(19) United States
(12) Patent Application Publication
(10) Pub. No.: US 2009/0172675 A1
(43) Pub. Date: Jul. 2, 2009

(54) Re-Entrant Atomic Signaling

(75) Inventors: Mark GROSSMAN, Palo Alto, CA (US); Nathan Hu, San Jose, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc.

(21) Appl. No.: 11/967,557

(22) Filed: Dec. 31, 2007

(51) Int. Cl. G06F 9/46

(52) U.S. Cl. 718/101; 718/108

(57) ABSTRACT

Systems for context switching a requestor engine during an atomic process without corrupting the atomic process. Typically an atomic process cannot be interrupted prior to completion and if it is interrupted, the process will terminated abnormally resulting in a corrupted transaction. Systems that allow for a controlled interruption of an atomic process without corruption with subsequent context switching are presented. The system consists of a context-switchable requester engine, a context switch controller, shared resource synchronizer, and a shared resource system. The system may also containing multiple local and remote context-switchable requestor engines as well as multiple local and remote shared resource systems. A method for context switching a requestor engine during an atomic process without corrupting the atomic process is also presented.

### BACKGROUND

1. Field of the Invention

The present invention relates to computer and software processing technology.

2. Related Art

An atomic transaction is a series of computer, processor, or database operations which either all occur, or all do not occur. Atomic transactions, or atomicity, prevents something, such as a database, from being merely partially updated. As known to those skilled in the art, such partial updates or partial transactions, can be more harmful than rejecting the entire transaction outright. As an example, if a person purchases a ticket to a concert, the ticket must either be paid for and the concert hall seat reserved, or neither paid for nor reserved. It is not acceptable for a customer to pay for a ticket without securing the requested seat or to reserve a seat but not successfully processing the payment.

In order to accommodate atomic transactions in a computational environment, specialized hardware or software systems are typically involved. These systems guarantee that an operation is non-interruptible, and they accomplish this by attempting to re-divert system resources or resource unavailability. However, this approach may not provide the optimum level of operability and efficiency. This is especially true, for example, in the case where a critical transaction needs to be processed but is delayed because a current atomic transaction has not completed. In conventional systems, the only options would be to wait until the transaction is completed, or to perform some type of restore or rollback to a previous known point in time. Neither of these options provides an efficient approach to interrupting an atomic process without adversely impacting overall system performance.

What are needed, therefore, are systems and/or methods to alleviate the aforementioned deficiencies. Particularly, what is needed is an efficient approach to interrupting an atomic process without adversely impacting overall system performance.

### BRIEF SUMMARY

Consistent with the principles of the present invention as embodied and broadly described herein, the present invention includes a context switching system including a context-switchable requestor engine that initiates a request to utilize a shared resource. A context switch controller controls the process for context switching the context-switchable requestor engine while a shared resource synchronizer controls access to a particular shared resource. The context switch controller may interrupt an atomic transaction prior to completion without corrupting the transaction by discarding the interrupted request and allowing the interrupted requestor to retry the request at a later time.

In another embodiment, a context switching system allows for remotely located context-switchable requestor engines. In addition, remotely located shared resources can also be accommodated with communications between the elements of the context switching system utilizing a global communications network.

In another embodiment, a method for context switching involves determining whether a shared resource is required by a context-switchable requestor engine, initiating a status request to a shared resource synchronizer in order to ascertain the status of available shared resources, returning the availability status of the shared resources as passed, failed, or incomplete to the context-switchable requestor engine, determining which of the shared resources are available, determining if a context-switchable requestor engine should be context switched, issuing a command to interrupt an atomic process transaction without failure if the context-switchable requestor engine is determined to be switched, terminating the atomic process without harm to the transaction, and then context switching the context-switchable requestor engine.

In this way an atomic transaction can be interrupted and the requestor context switched without corrupting the transaction in order to allocate the requestor to another task. This results in not requiring the requestor to wait until the atomic transaction completes and allows for the reallocating of resources thereby providing a higher level of efficiency and throughput for critical transactions.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 is a system diagram depicting an implementation of a system for managing a shared resource with the ability to context switch in accordance with the present invention.

FIG. 2 is a system diagram depicting the system illustrated in FIG. 1 utilizing a global communications network.

FIG. 3 is a system diagram depicting the context switch controller and the shared resource synchronizer used in the illustrations of FIGS. 1 and 2 configured to manage multiple shared resources with the ability to context switch amongst multiple engine requesters.

FIG. 4 is a system diagram depicting the system shown in the illustration of FIG. 3 utilizing a global communications network.

FIG. 5 is a flowchart diagram depicting operation of a system for managing a shared resource with the ability to context switch.

FIG. 6 is a flowchart of an exemplary method of practicing an embodiment of the present invention.

### DETAILED DESCRIPTION

While specific configurations, arrangements, and steps are discussed, it should be understood that this is done for illustrative purposes only. A person skilled in the pertinent art(s) will recognize that other configurations, arrangements, and steps may be used without departing from the spirit and scope of the present invention. It will be apparent to a person skilled in the pertinent art(s) that this invention may also be employed in a variety of other applications.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to incorporate such a feature, structure, or characteristic in connection with other embodiments whether or not explicitly described.

The present invention relates to context switching of atomic transactions. In embodiments of this invention, context switching occurs by interrupting an incomplete atomic transaction in order to not require the requestor to wait until the atomic transaction completes, which in turn, allows for the reallocating of resources thereby providing a higher level of efficiency and throughput for critical transactions.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

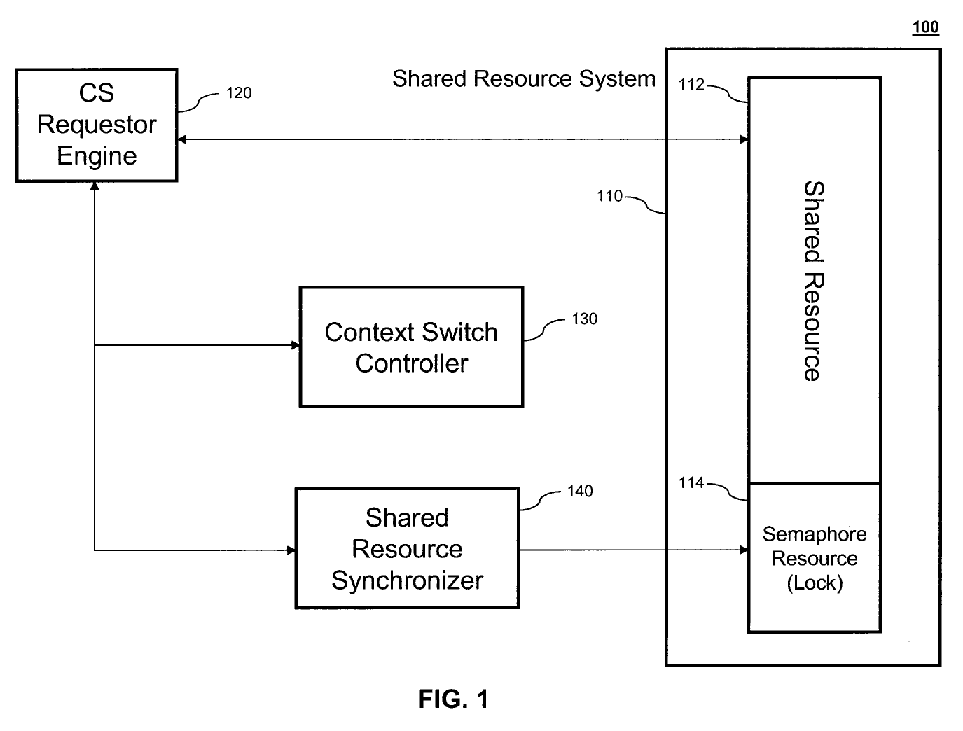

FIG. 1 is an illustration of a system 100 for managing a shared resource with the ability to context switch according to an embodiment of the present invention. System 100 contains four primary components. A context-switchable (CS) requestor engine 120 initiates a request to utilize a shared resource, such as shared resource system 110 in FIG. 1. The shared resource system 110 includes a particular shared resource 112, which could be a memory or portion thereof, and a semaphore resource 114. The semaphore resource 114 restricts access to the shared resource 112. A context switch controller 130 controls the context switching process and is responsible for context switching of the context-switchable requestor engine 120. It may determine such context switching is required using a number of means, including but not limited to responding to an interval timer or to a request from an external host processor. A shared resource synchronizer 140 manages all requests for shared resources, such as for the shared resource system 110 used by the context-switchable requestor engine 120.

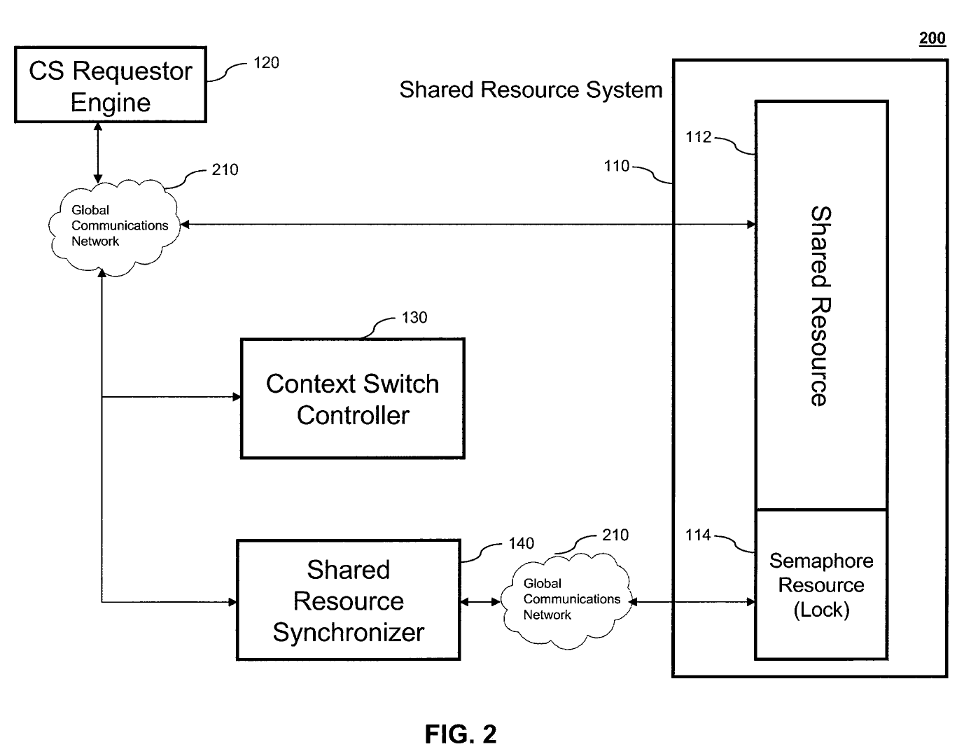

FIG. 2 is an illustration a context switching system 200 using components of the system 100 of FIG. 1 in a global communications network. The context switching system 200 includes the context-switchable requestor engine 120. In a manner similar to the system 100 of FIG. 1, the context-switchable requestor engine 120 communicates with the other elements in the context switching system 200 such as the shared resource system 110, the context switch controller 130, and the shared resource synchronizer 140. In the system 200 of FIG. 2, however, the context-switchable requestor engine 120 communicates with the other elements via a global communications network 210.

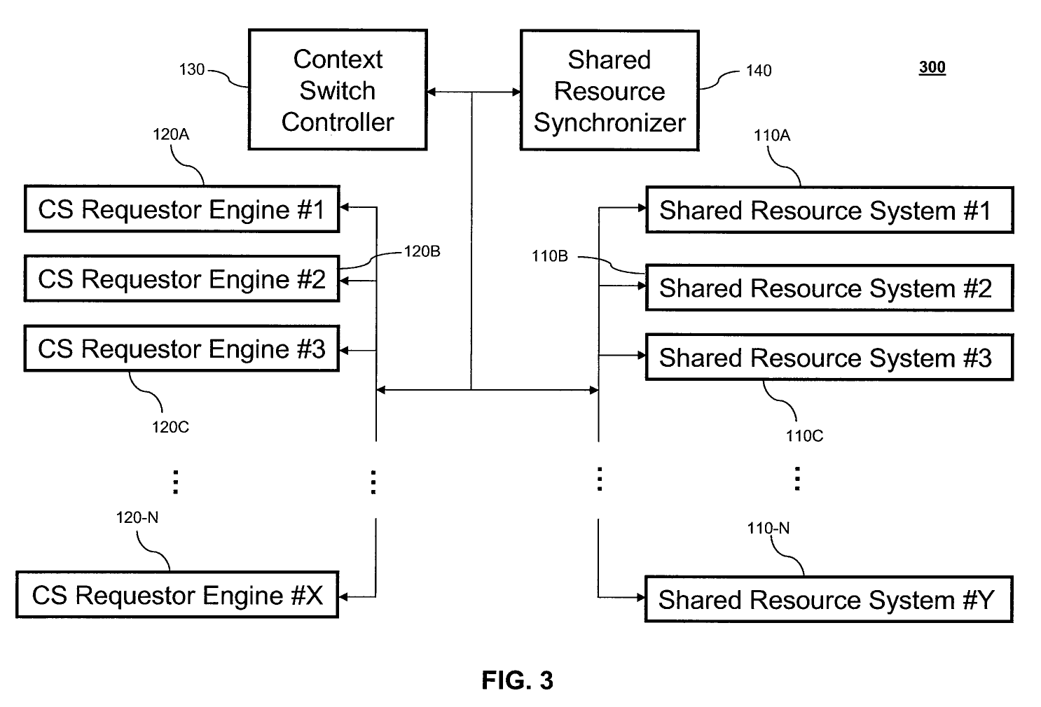

FIG. 3 is an illustration of a context switching system 300 utilizing a plurality of context-switchable requestor engines and a plurality of shared resource systems according to an embodiment of the present invention. The context switching system 300 includes a single context switch controller 130 configured to control the context switching process of context-switchable requestor engines 120A through 120-N, along with shared resource systems 110A through 110-N. There is also a single shared resource synchronizer 140 coordinating and controlling requests from, and allocation of, shared resource systems 110A through 110-N.

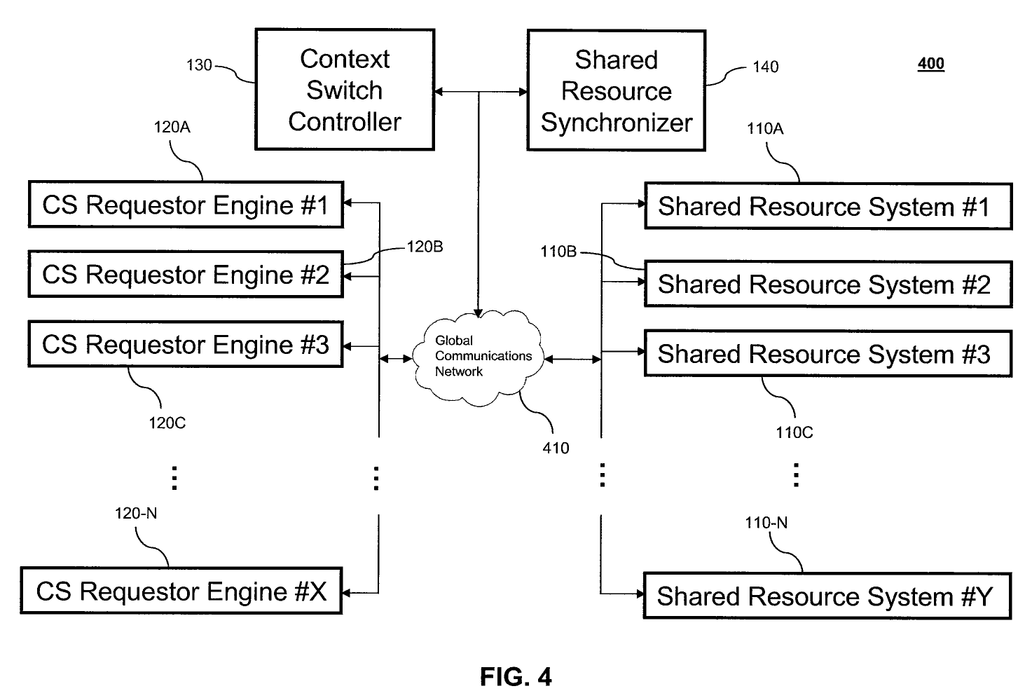

FIG. 4 is an illustration of a context switching system 400 utilizing a plurality of context-switchable requestor engines and a plurality of shared resource systems communicating via a global communications network 410 according to an embodiment of the present invention. In FIG. 4 the context switch controller 130 and shared resource synchronizer 140 communicate with context-switchable requestor engines 120A through 120-N and all of the shared resource systems 110A through 110-N through the global communications network 410.

In an alternative embodiment of the present invention, both local and remote context-switchable requester engines could be used in various combinations. In such an embodiment, as an example, a first group of context-switchable requestor engines 120 could be connected locally, as illustrated in FIG. 3. At the same time, another group of context-switchable requester engines 120 could be connected via the global communications network 410, as illustrated in FIG. 4.

In like manner as the alternative embodiment discussed above, the present invention can also include variations and combinations where both local and remote shared resource systems can be utilized.

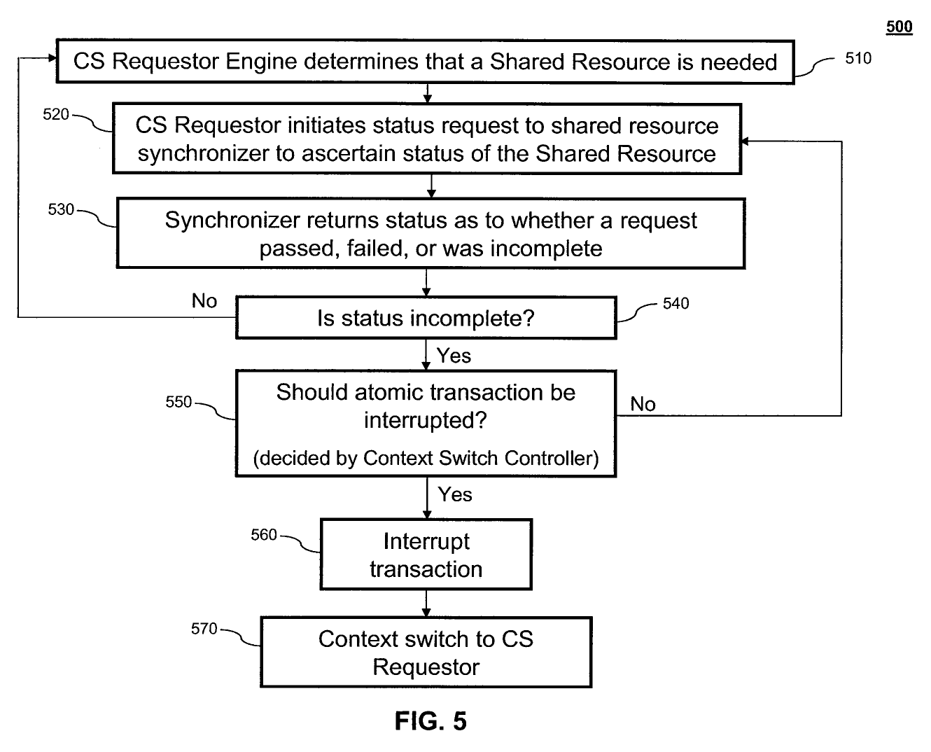

FIG. 5 is a flowchart of exemplary operation 500 of a context switching system in accordance with the present invention. In step 510, a context-switchable requester engine determines whether a shared resource is needed. The context-switchable requestor engine then initiates a status request 520 to the shared resource synchronizer to ascertain the status of either a particular shared resource, or of all, or a subset of shared resources. The shared resource synchronizer then returns a status 530 as to whether a status request passed, failed, or was incomplete, as indicated in the Context Switching Decision Table shown below.

A passed status indicates that the context-switchable requester engine may immediately access the resource. An incomplete status indicates that there is an atomic transaction in process and in order to gain access to the resource, the atomic transaction would have to be interrupted with the context-switchable requestor engine then being allowed to context switch.

In steps 540 and 550 there are two logical conditions that need to be ascertained in order to allow the system to interrupt an atomic transaction, as depicted in step 560. Step 540 conditions are incorporated in the column labeled “Status Response.” Similarly, step 550 conditions are incorporated in the column labeled “Is Context Switching Required?”, and steps 560 and 570 actions are incorporated in the column labeled “Action” of the Context Switching Decision Table.

Context Switching Decision Table

| | Is Context | |
|---|---|---|
| Status | Switching | |
| Response | Required? | Action |
| Incomplete | Yes | Interrupt Atomic Operation, |
| | | Context Switch |
| Incomplete | No | Retry Status Request (Old) |
| Pass | Yes | Context Switch |
| Pass | No | Continue |
| Fail | Yes | Context Switch |
| Fail | No | Retry Status Request (New) |

In accordance with the present invention, the following table depicts a process where an atomic transaction can be interrupted without corrupting the entire transaction: This table depicts the conditions and corresponding actions of the shared resource synchronizer and a context-switchable requester engine during possible activities of the shared resource synchronizer.

| | SRC | | |
|---|---|---|---|
| | Response | | What happens |
| | to | Is CSRE “A” | after preemption |
| SRC Current | CSRE “A” | Preemptable at | during this SRC |
| Activity | Request | this time? | activity |
| Acting on | Incomplete | Yes | CSRE A's request |
| another CSRE's | | | discarded; CSRE A |
| request | | | re-issues when |
| | | | context restored |
| Preparing | (none) | No | No preemption |
| response to | | | until response sent |
| CSRE A's | | | to CSRE |
| request | | | |
| Arbitrating | Incomplete | Yes | CSRE A's request |
| next request | | | discarded; CSRE A |
| | | | re-issues when |
| | | | context restored |
| Issuing | Incomplete | Yes | CSRE A's request |
| memory read | | | and read data |
| for CSRE A's | | | discarded; CSRE A |
| semaphore | | | re-issues when |
| operation | | | context restored |
| Modifying | Incomplete | Yes | CSRE A's request |
| CSRE A's | | | and modified data |
| semaphore | | | discarded; CSRE A |
| resource value | | | re-issues when |
| | | | context restored |
| Issuing | Pass or Fail | No | CSRE A's |
| memory write | | | requested atomic |
| for CSRE A's | | | operation is |
| semaphore | | | complete; continue |
| resource | | | to next activity |

SRC = Shared Resource Synchronizer
CSRE = Context-Switchable Requestor Engine

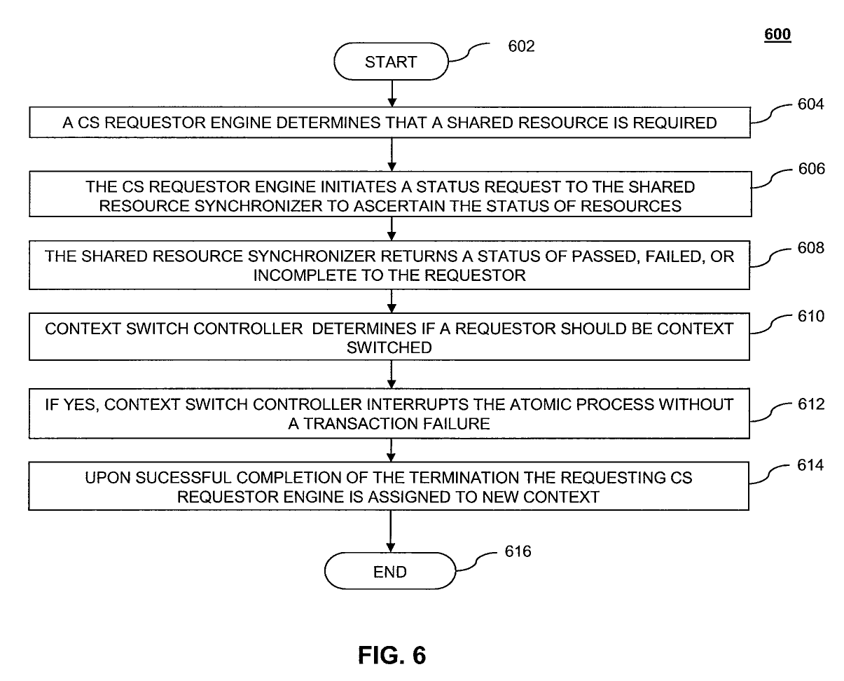

FIG. 6 is a flowchart depicting a method 600 for context switching, according to the present invention. Method 600 begins at step 602 and immediately proceeds to step 604. In step 604, a context-switchable requester engine determines that a shared resource is required. In step 606, the context-switchable requestor engine initiates a status request to the shared resource synchronizer to ascertain the status of shared resources.

In step 608, the shared resource synchronizer returns a request status of passed, failed, or incomplete for a shared resource to the context-switchable requestor engine. In step 610, the context switch controller will determine if a context-switchable requestor engine should be switched. In step 612, if the context switch controller determines that there should be a context switch, it will interrupt the atomic process without a transaction failure. In step 614, upon a successful completion of the termination of the atomic process, the context-switchable requestor engine that made the request for the shared resource is assigned to another context. Method 600 ends at step 616.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A context switching system, comprising:
a context-switchable requester engine coupled with a shared resource system, a context switch controller and a shared resource synchronizer;
the shared resource system coupled with the context-switchable requester engine and the shared resource synchronizer;
the context switch controller coupled with the context-switchable requestor engine and shared resource synchronizer; and
the shared resource synchronizer coupled with the context-switchable requester engine, the context switch controller, and the shared resource system;
wherein said context-switchable requestor engine, shared resource system, context switch controller, and shared resource synchronizer have the ability to context switch an atomic transaction prior to completion.

2. The context switching system of claim 1, wherein the context-switchable requestor engine may initiate a request to utilize a shared system resource.

3. The context switching system of claim 1, wherein the shared resource system comprises a shared resource and a semaphore resource.

4. The context switching system of claim 1, wherein the context switch controller controls a process for context switching the context-switchable requester engine.

5. The context switching system of claim 1, wherein the shared resource synchronizer restricts access to a shared resource.

6. The context switching system of claim 1, wherein the context switch controller may interrupt an atomic transaction prior to completion without corruption of the transaction.

7. The context switching system of claim 6, wherein the context switch controller can interrupt an atomic transaction at any time other than during the shared resource synchronizer's operation to commit the atomic transaction.

8. The context switching system of claim 1, wherein there is a plurality of context-switchable requester engines.

9. The context switching system of claim 1, wherein there is a single shared resource synchronizer.

10. The context switching system of claim 1, wherein a context-switchable requestor engine communicates with a context switch controller and a shared resource synchronizer utilizing a global communications network.

11. The context switching system of claim 1, wherein the shared resource system communicates with a context-switchable requestor engine and the shared resource synchronizer utilizing a global communications network.

12. The context switching system of claim 1, wherein the shared resource synchronizer implements atomic transactions utilizing a sequence of discrete memory read and write transactions.

13. A context switching method for managing shared resources with the ability to context switch, comprising:
determining whether a shared resource is required by a context-switchable requestor engine;
initiating a status request to a shared resource synchronizer in order to ascertain the status of available shared resources;
returning the status of the request for shared resources as passed, failed, or incomplete to the context-switchable requester engine;
evaluating the availability status of the shared resource;
determining if a context-switchable requester engine should be context switched;
interrupting an atomic process transaction without failure if the context-switchable requestor engine is determined to be switched;
terminating the atomic process without harm to the transaction; and
context switching the context-switchable requester engine.

14. The method of claim 13, wherein there is a plurality of context-switchable requestor engines.

15. The method of claim 13, wherein there is a plurality of shared resources.

16. The method of claim 15, wherein there is a determination of which shared resources are available to a context-switchable requestor engine.

17. The method of claim 16, wherein there is a determination of which context-switchable requestor engine is to be context switched.

18. The method of claim 13, wherein there is a single shared resource synchronizer.

19. The method of claim 13, wherein a context-switchable requestor engine communicates with a context switch controller and a shared resource synchronizer utilizing a global communications network

20. The method of claim 13, wherein the shared resource system communicates with a context-switchable requester engine and the shared resource synchronizer utilizing a global communications network.

21. The method of claim 13, wherein a context-switchable requestor engine may reinitiate a request for an interrupted atomic transaction.

22. A system for managing resources shared among context-switchable requester engines with the ability to context switch, comprising:
means for determining that a shared resource is required by a context-switchable requester engine;
means for initiating a status request to a shared resource synchronizer in order to ascertain the status of a shared resource;
means for returning the status of the request for a shared resource as passed, failed, or incomplete to the context-switchable requestor engine;
means for determining which resources are available;
means for determining if a context-switchable requestor engine should be context switched;
means for interrupting an atomic process transaction without failure if the context-switchable requestor engine is determined to be switched;
means for terminating the atomic process without harm to the transaction; and
context switching the context-switchable requestor engine.

23. The system of claim 22, further comprising means for allowing a context-switchable requester engine to reinitiate a request for an interrupted atomic transaction.
